(19) United States
(12) Patent Application Publication
(10) Pub. No.: US 2024/0416548 A1
(43) Pub. Date: Dec. 19, 2024

(54) METHOD FOR PRODUCING CROSS-LAMINATED TIMBER PANELS WITH CUTOUTS AND WOODEN PANEL PRODUCTION DEVICE

(71) Applicant: MINDA Industrieanlagen GmbH, Minden (DE)

(72) Inventors: Hubertus ZEDDIES, Hannover (DE); Nils BEGEMANN, Bad Oeynhausen (DE)

(21) Appl. No.: 18/672,792

(22) Filed: May 23, 2024

(30) Foreign Application Priority Data
Jun. 19, 2023 (DE) 10 2023 116 006.0

(51) Int. Cl. B27M 3/00; B32B 37/00; B32B 37/12; B32B 37/18; B32B 38/00; B32B 38/18

(52) U.S. Cl. CPC B27M 3/0053; B32B 37/0046; B32B 37/12; B32B 37/18; B32B 38/0004; B32B 38/1816; B32B 2307/304; B32B 2317/16

(57) ABSTRACT

A device for joining multi-layered panels made of individual boards has a height-adjustable workbench. layers of boards arranged at an angle to each other and joined together. A guide for the material is provided at least on one side of the workbench, preferably on two adjoining sides. The device comprises at least one transport device for transporting boards to the processing position.

### FIELD OF THE INVENTION

The invention relates to a method for producing cross-laminated timber panels with cutouts that are constructed, in particular are composed of, at least one longitudinal layer, in which the boards are arranged in rows parallel to each other in a longitudinal direction, and at least one transverse layer, in which the boards are arranged in rows parallel to each other in a transverse direction. According to a second aspect, the invention relates to a wooden panel production device.

### BACKGROUND

EP 3 542 981 B1 discloses a press for pressing and glueing wooden boards to produce laminated panels. This press can be used to produce, among other things, wall elements composed of boards that have cutouts for windows or doors; to this end, planks of varying lengths can be introduced one after the other into the joining system where they are positioned and, once positioning is complete, pressed together. However, the individual boards only extend with their longitudinal axis in the longitudinal direction of the panel.

To obtain sufficient stability of a wall element, multiple wooden panels should be glued together to create a cross-laminated timber panel in such a way that the longitudinal axes of the boards intersect in overlapping wooden panels, i.e. these are arranged alternately parallel in a longitudinal direction and a transverse direction. For example, in the outer layers the longitudinal axes of the boards extend in the transverse direction to the wooden panel and, in the at least one inner layer, in the longitudinal direction to the wooden panel. Basically, the individual panels are always glued together to form a cross-laminated timber panel in such a way that the longitudinal axes of the boards of adjacent layers intersect.

EP 3 795 315 B1 discloses a press with which wooden boards of any desired width and length can be continually glued to create laminated wooden panels of any desired width and length without the surface of the laminated panels being subsequently processed. If the wooden boards are not to be glued together to form laminated panels, the joining system should be used as a cross conveyor.

It is advantageous to produce cross-laminated timber panels that are to be used as wall elements in house construction directly with window and door cutouts, as this saves material and avoids waste. The problem during production of such cross-laminated timber panels is that the boards for the wooden panels must be laid and glued once in their longitudinal direction transverse to the longitudinal direction of the desired wooden panel (transverse layer) and once in the longitudinal direction of the desired wooden panel (longitudinal layer). This requires two different joining systems.

DE 10 2010 026 578 B4 presents a method for producing a cross-laminated timber panel where a longitudinal layer of boards is first laid, said boards being aligned in the longitudinal direction of the cross-laminated wooden panel so that at least one of the boards protrudes beyond the other boards in the longitudinal direction. A first transverse layer of boards is then laid on the first longitudinal layer, said boards being aligned in the transverse direction of the cross-laminated timber panel. The layers are subsequently pressed in the longitudinal direction, the transverse direction and in the direction perpendicular to both directions.

EP 2 618 972 B1 discloses a method for producing multi-layer panel elements in which the boards are of different lengths to form a cutout and are positioned according to the position of the cutout.

EP 1 369 214 B1 presents a method for joining multi-layered panels in which the positions for nailing the boards are calculated using the board widths of the previous layer and the nailing positions of the subsequent row are matched to the underlying boards.

WO 2012/104100 A1 discloses a method for fitting a multi-layer solid wood composite component with at least one layer of boards orientated parallel to one another and pivoted relative to the boards of the preceding layer. The boards are placed one after the other on the top layer and nailed to this layer or the layer below it on a stationary portal until a layer is reached on which the next layer is placed.

### SUMMARY

The invention aims to produce both the longitudinal layer and the transverse layer of a cross-laminated timber panel in the same or an identical jointing system.

According to a first aspect of the invention, the problem is solved in a method comprising the following steps:
a) in a first step, the boards in the rows in which the cutouts are located are divided into individual boards to create the cutouts in the longitudinal layer and then laid to form a first longitudinal layer and glued together on their longitudinal sides,
b) in a second step, a second longitudinal layer is first formed from a plurality of individual boards to produce the cutouts, wherein individual boards are laid in several rows and glued together on their longitudinal sides to allow for the cutouts, the second longitudinal layer being stepped in the transverse direction, wherein the area of the second longitudinal layer corresponds to the area of the first longitudinal layer without the cutouts,
c) in a third step, the second longitudinal layer is divided into at least two parts and the divided parts are rotated by 90°,
d) in a fourth step, the parts rotated by 90° are laid together to form the transverse layer and joined together in such a way that the cutouts are also formed here,
e) in a final step, the transverse layer is laid on the longitudinal layer and the overlapping layers are glued together.

These steps render it possible to produce the longitudinal layer and the transverse layer in one and the same joining system or in two structurally identical joining systems because only longitudinal layers are laid and pressed and the transverse layers required are created by dividing a second longitudinal layer into multiple partial panels and rotating the divided parts by 90°. The longitudinal direction of the boards in the individual layers thus runs at right angles to each other. The size and number of partial panels required must of course be calculated in advance. It is also possible to re-divide partial panels.

The two outer layers of a cross-laminated timber panel are preferably composed solely of wooden panels that have been glued together. In the inner layers, an insulating panel can be arranged between two boards. The insulating panel can be wider than the boards. In the joining station, wooden boards and fiber panels, preferably wood fibre panels, are then glued together alternately at the sides.

Preferably, one row contains a maximum of five individual boards.

In one embodiment example, the boards are transported to the joining station in the longitudinal direction and positioned via adjustable end stops. After positioning, they are introduced into the joining station in the transverse direction, i.e. transversely to their longitudinal axis.

It is advantageous to trim the lateral edges of the glued cross-laminate timber panels before further processing so as to calibrate them and therefore achieve the desired final dimensions.

At two opposite lateral edges (right and left in the diagram, or at the beginning and end in the longitudinal direction), the longitudinal layers, which are later to be used as transverse layers, are preferably bordered by solid wood, i.e. boards, if fiberboards are placed between them.

According to a second aspect, the invention relates to a wooden panel production device for producing cross-laminated timber panels with cutouts that are constructed of at least one longitudinal layer, in which the boards are arranged in rows parallel to each other in a longitudinal direction, and at least one transverse layer, in which the boards are arranged in rows parallel to each other in a transverse direction, with
a) a cut-off device that is configured to divide the boards in the rows that feature the cutouts into individual boards in order to create the cutouts in the longitudinal layer,
b) a glueing device that is configured to glue the longitudinal sides of the boards,
c) a joining station for laying and pressing the boards to create a first longitudinal layer,
d) wherein the cut-off device is configured to divide a second longitudinal layer stepped in the transverse direction RQ, the area of which corresponds to the first longitudinal layer without the cutouts, into at least two partial panels,
e) wherein the wooden panel production device comprises a rotation device, which is configured to rotate the divided partial panels by 90°,
f) wherein the joining station is configured to lay the parts rotated by 90° together to form the transverse layer and to join them together in such a way that the cutouts are also formed here.

The cut-off device is, for example, a milling tool or a saw, in particular a chop saw or a circular saw.

The rotation device is, for example, a rotary tilting table, a rotary damper, a rotary flap, a rotary carousel, a gripper, a lifter, in particular a vacuum suction cup or a vacuum lifter, or a handling robot.

Preferably, the wooden panel production device has a joining device which is configured to place the transverse layer Q on the longitudinal layer L and to glue the overlapping layers together. The joining station preferably comprises the joining device; alternatively, it is designed as a separate device.

Preferably, the wooden panel production device has a longitudinal layer formation device, which is configured to form the second longitudinal layer from a plurality of individual boards in multiple rows to create the cutouts, wherein individual boards are laid in several rows and glued together on their longitudinal sides to allow for the cutouts, the second longitudinal layer being stepped in the transverse direction R_{Q}, wherein the area of the second longitudinal layer corresponds to the area of the first longitudinal layer without the cutouts, The joining station preferably comprises the longitudinal layer formation device. In this case, the second longitudinal layer is produced in the same device in which it is later reassembled as a transverse layer. Alternatively, the longitudinal layer formation device is separate.

In a preferred embodiment, the wooden panel production device has a transport device, which is configured to transport the boards in the longitudinal direction to the joining station and has adjustable end stops for positioning the boards, and a pushing device, which is configured to introduce the boards into the joining station in the transverse direction after positioning. For example, the transport device is an electric pallet conveyor, a vehicle, in particular an autonomous vehicle, a lift, a shaft conveyor, an overhead conveyor, an aerial tramway, a trolley conveyor, a rail conveyor, a roller conveyor, a belt conveyor, a chain conveyor or an underfloor drag chain conveyor. The pushing device is, for example, a slide, in particular a mechanical, pneumatic or hydraulic slide.

The wooden panel production device preferably has a trimming device that is configured to trim the cross-laminated timber panels before they are processed further in order to calibrate them. The trimming device is, for example, a milling tool or a saw, in particular a circular saw.

Preferably, the joining station is configured to arrange an insulating panel between each of the boards for the transverse layer. The insulating panels are preferably wider than the boards.

The wooden panel production device preferably has a control device, which is configured to control the longitudinal layer formation device of the cut-off device, the transport device, the glueing device, the joining device, the rotation device, the pushing device, the trimming device, the rotation device and/or the joining device, so that the wooden panel production device automatically conducts the method according to the invention.

### DESCRIPTION OF THE DRAWINGS

In the following, an embodiment example of the invention will be explained in more detail with the aid of accompanying figures. They show:

FIG. 1 is a longitudinal layer for a cross-laminated timber panel;

FIG. 2 is a transverse layer for a wood-based material panel;

FIG. 3a is the schematic representation of the arrangement of the boards in a second longitudinal layer to form a transverse layer and the processing steps involved;

FIG. 3b is the schematic representation of the arrangement of the boards in a second longitudinal layer to form a transverse layer and the processing steps involved;

FIG. 4 is the schematic representation of the process for joining the boards;

FIG. 5 shows the positioning of five boards of varying length and position in a path-time diagram; and

FIG. 6 is a schematic representation of the positioning of the boards in the joining station.

### DESCRIPTION

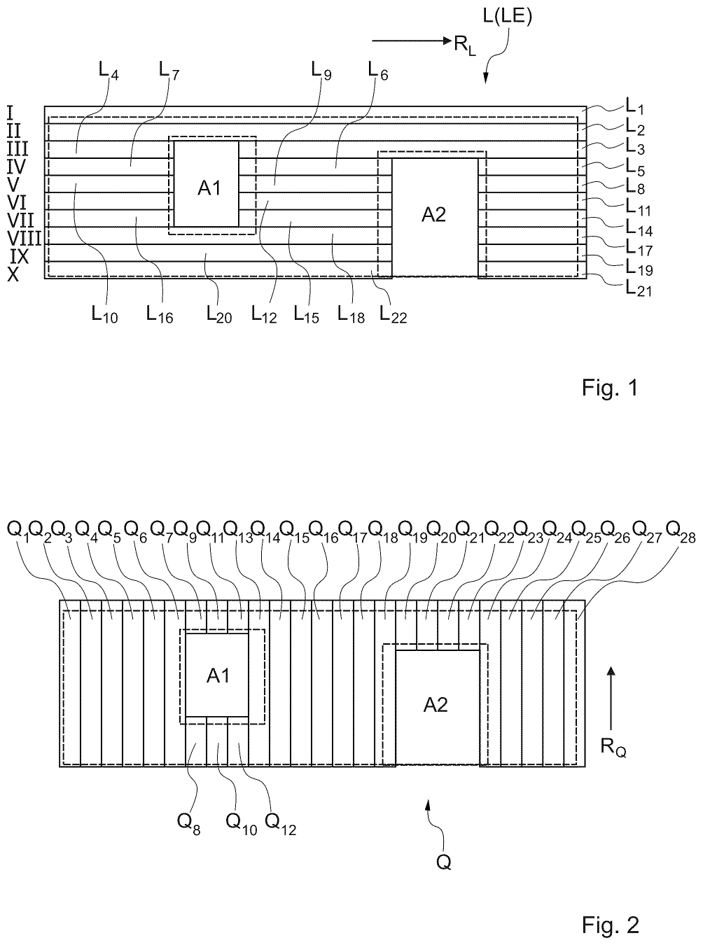

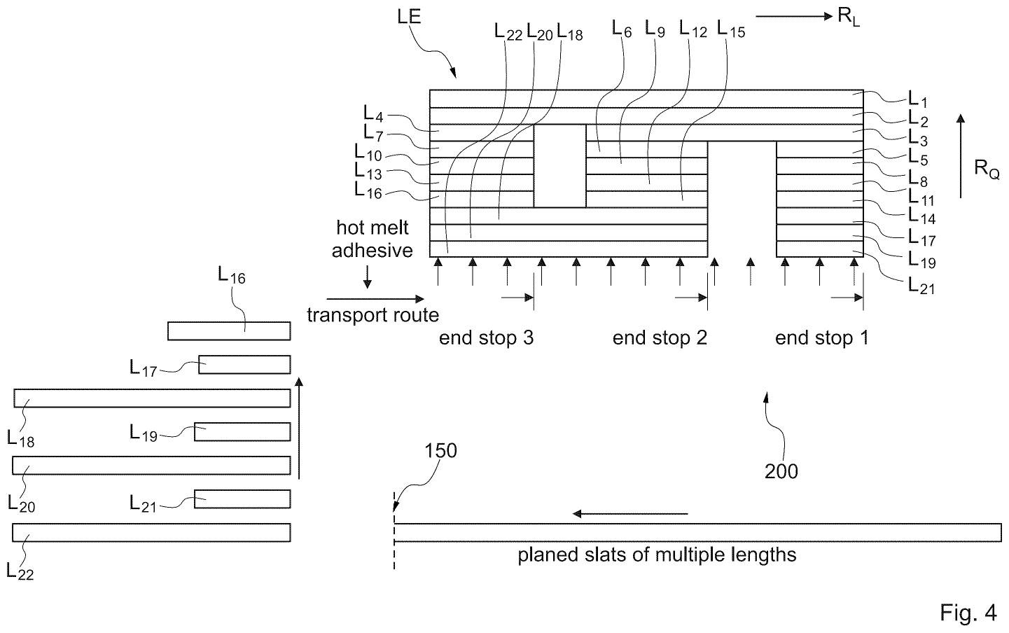

FIG. 1 shows a longitudinal layer composed of a plurality of boards L₁, L₂, . . . Lᵢ, . . . L₂₁, L₂₂, which are arranged in rows I, II, III, IV, . . . X and glued together. A cutout A₁ for a window and a cutout A₂ for a door are provided in the longitudinal layer L. FIG. 4 corresponds to the representation according to FIG. 1 and demonstrates that the first uncut board L₁ is first introduced into the joining system and moved forward until the end stop 1.

The second uncut board L₂ is then coated with glue, especially a hot melt adhesive, on the longitudinal edge facing the first board L₁, introduced into the joining system 1, transported up to the end stop 1, and then pushed in the transverse direction R_{Q} against the first board L₁ and pressed with it. The contact between the hot melt adhesive and the longitudinal edge of the first board L₁ causes the former to cure quickly, fixing the two boards L₁, L₂ together.

To begin the window cutout A₁, the next board L₃ is designed to be shorter. It is glued on its lateral side facing the second board L₂, transported into the joining system up to the end stop 1, then pushed in the transverse direction R_{Q} against the second board L₂ and joined to it using the hot melt adhesive.

The fourth board L₄ is designed to be even shorter and, after first being glued on its lateral edge facing the third board L₃, is transported into the joining system up to the end stop 3 and then pushed in the transverse direction R_{Q} against the board L₂ and joined to it. Accordingly, the next cut boards L₅, L₆, up to L₂₁ and L₂₂, are glued in order to form the first part of the door cutout A₂, moved into the joining system against end stop 1, end stop 2 or end stop 3, and joined in the transverse direction so as to join them with one or the previously glued boards L₁. This produces a longitudinal length L.

For practicality, the boards Lᵢ in a row I, II, . . . IX, X are first positioned and then moved together against the previously laid boards. This means that, in row IV for example, board L₅ is initially transported against end stop 1, board L₆ against end stop 2 and board L₇ against end stop 3, then all three boards L₅, L₆, L₇ are pushed together against the boards L₃ and L₄ previously joined in row III and pressed in order to fix them (see FIG. 4). The end stops 1, 2 and 3 are arranged such that they can be moved in the longitudinal direction R_{L} in order to achieve high variability for the cutouts A₁, A₂ to be introduced. Additional end stops can be provided if further cutouts A₁ are desired.

To obtain a stable wall element, a cross-laminated timber panel must be produced and a transverse layer Q glued to the longitudinal layer L using wood glue and then pressed. In the process, the cutouts A₁ and A₂ must of course be in the same location.

The door cutout A₂ may render the cross-laminated timber panel unstable during transport to the construction site. To avoid breaking or tearing, boards L₂₁ and L₂₂ could be made as a single long board the door cutout then completed by cutting this last board once at the construction site.

The transverse layer Q to be glued to the longitudinal layer L can be seen in FIG. 2. Boards Q₁, Q₂, Q₃, . . . Q₁ . . . Q₆, Q₇, Q₈ are glued together with their longitudinal axis parallel to the transverse direction R_{Q}. Due to the alignment of boards Q₁, the transverse layer Q cannot be produced immediately in the same joining system as the longitudinal layer L, which is clearly demonstrated when comparing FIGS. 1 and 2, as the boards have to be guided in different directions.

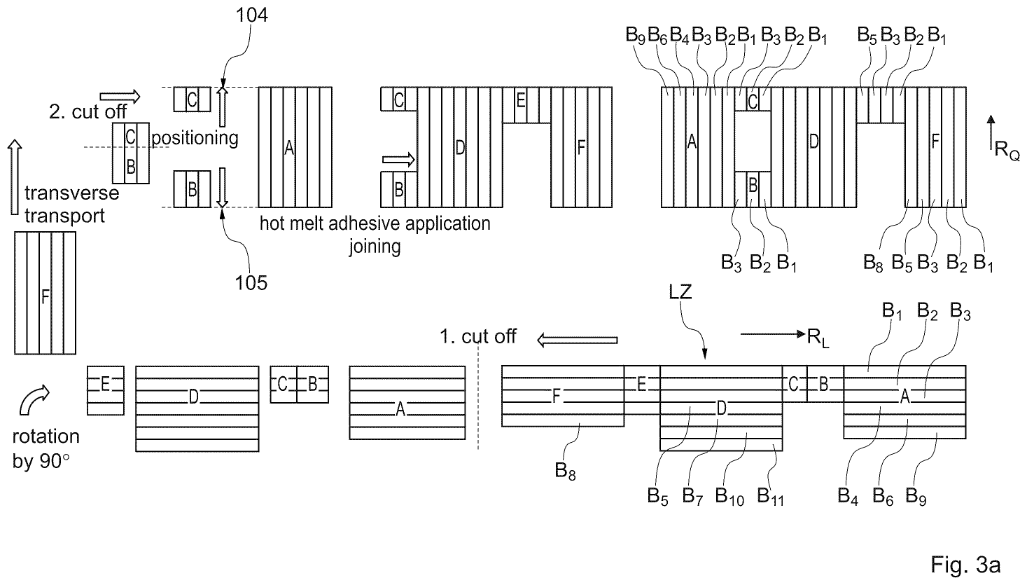

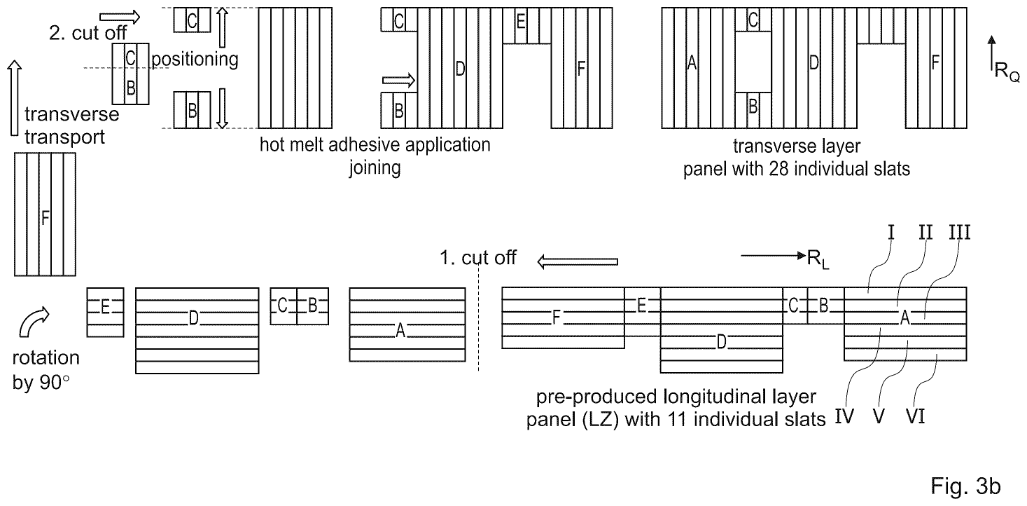

How the transverse layer Q is produced is shown in FIGS. 3a and 3b (starting at the bottom right and ending at the top right), which, one after the other, illustrate the production process. FIGS. 3a and 3a are identical. They simply show different reference signs so as to improve clarity.

First, a second longitudinal layer LZ is produced in a longitudinal layer formation device, not depicted, with boards Bᵢ, which are aligned with their longitudinal axes in the longitudinal direction R_{L}. Production is carried out as described above. For example, the joining station 200 can comprise the longitudinal layer formation device, so that the second longitudinal layer LZ is produced in the same device in which it is later reassembled as the transverse layer Q.

The three upper boards B₁, B₂, B₃ in rows I, II, III extend across the entire length. Conversely, boards B₄ to B₁₁ in rows IV, V, VI are designed to be shorter, resulting in a stepped panel in the longitudinal direction R_{L}.

The finished wooden panel (top right-hand illustration) demonstrates that different sized panels A, B, C, D, E, F can be positioned next to each other and glued together to form the cutouts A₁, A₂. The size of panels B and C and E can be calculated from the size of the cutouts A₁, A₂ to be produced. The size of panels A, D and F can also be calculated. Correspondingly, boards B₁, B₂, . . . B₁, . . . B₁₀, B₁₁ are cut to size using a cut-off device 150, for example in the form of a chop saw, and laid such that smaller partial panels A, B, C, D, E and F can be cut from the laid wooden panel, which is visible in the bottom left-hand illustration.

In the transition from the lower to the upper illustrations, the divided panels are rotated by 90°. Here, panel F, which was cut off at the rear end of the laid wooden panel, is rotated first, transported in the transverse direction R_{Q} and positioned by guiding it against an end stop that is not visible. The partial panel E is then rotated by 90°, glued with hot melt adhesive on its right-hand lateral edge as shown in the drawing, transported in the transverse direction R_{Q} and pushed against the already positioned partial panel F and pressed together with it. In the same way, the partial panels D, C/B and A are each rotated by 90°, positioned in the transverse direction R_{Q} if necessary and joined to the already positioned partial panel with the glued lateral edge.

As can be seen in the lower illustrations in FIG. 3, the partial panels B/C are not divided, but are jointly rotated by 90° and then transported in the transverse direction R_{Q}. Since these two partial panels B, C are too small, it makes more sense not to cut them until after being rotated by 90° and then to position them against end stops 104, 105 in order to form the lintel (partial panel C) and the sill (partial panel B) of window cutout A₁. The end result is the representation of the transverse layer Q, as shown in the top right of FIG. 3a. Eleven boards Bᵢ, which were laid and glued to the second longitudinal layer LZ, become 28 boards (Q₁, Q₂, . . . Q₂₈) in the transverse layer Q due to the multiple division.

FIG. 3b corresponds to FIG. 3a, in which only the reference signs for the individual boards Bᵢ or Qᵢ have been eliminated. This transverse layer Q created from the second longitudinal layer LZ is then gripped, the first longitudinal layer LE is coated with wood glue on its upper side and the two wooden panels, longitudinal layer L and transverse layer Q, are pressed together by the joining device until the wood glue has hardened and the cross-laminated timber panel is produced. For example, the joining station 200 can comprise the joining device, which is configured to place the transverse layer Q on the longitudinal layer L and to glue the superimposed layers together.

The cross-laminated timber panel can basically be constructed and/or consist of any number of wooden panels. Three-ply and five-ply cross-laminated timber panels are preferred, but seven-ply and nine-ply cross-laminated timber panels are also produced. It is important that the course of the longitudinal axis of the boards Lᵢ, Qᵢ of the adjoining panels cross each other.

FIG. 4 illustrates that a planed slat of multiple lengths, i.e. a length that can exceed the maximum length of a board Lᵢ, is first fed into a finger-jointing line. A cut-off device 150, for example in the form of a chop saw, then cuts the first board L₁ to the desired length from this planed slat. This board is then transported in the transverse direction R_{Q} and then moved in the longitudinal direction R_{L} against the end stop 1 The left-hand illustration of individual boards shows the sequence required to join the longitudinal layer L of the wooden panel.

The functional sequence for joining the boards L₁, L₂, . . . Lᵢ . . . L₂₂ is described below with reference to FIG. 6. The boards required for a joining plane are available cut to length in a buffer not shown here. They are accelerated to approximately 180 m/min in the longitudinal direction with a mangle, not shown, and guided through a side gluing process on an edge with hot melt adhesive. They then continue at, for example, 180 m/min over a 16.5 m long transport device 100, for example in the form of a roller conveyor with rollers 101. The rollers 101 are set at an angle and a width-adjustable ruler 102 is provided at the rear of the joining station P. The transport device 100 is divided into fifteen individually driven sections, as shown schematically in FIG. 6.

A continuous roller bar with rollers, which can be adjusted to the board thickness, is arranged above the transport device 100. These non-driven rollers ensure the safe movement of short and light components.

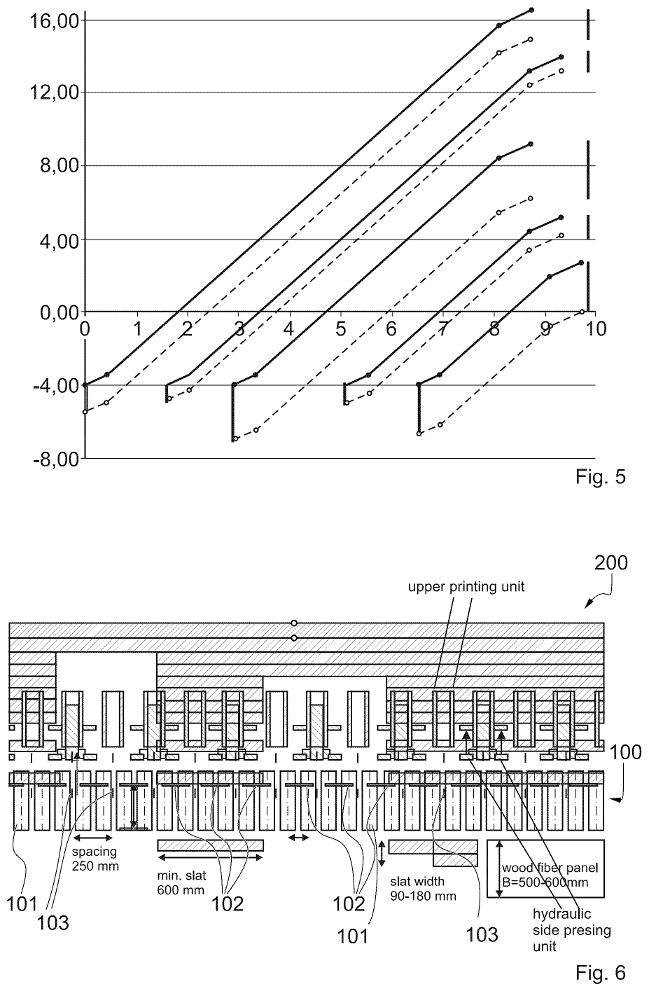

The diagram in FIG. 5 shows the positioning of five boards of different lengths and positions. The distance is plotted on the ordinate axis and the time on the abscissa. The solid line represents the front edge of a board, the dashed line below it is the rear edge of a board, and the vertical distance between the lines corresponds to the length of a board. At a running speed of 180 m/min, all boards are in their joining position after 9.8 seconds. The slats run through the joining station 200 with an offset of around 1 s (equivalent to 3.0 m) between the rear edge of the leading board and the front edge of the following board.

All five end stops are positioned in the position of the front edge of the respective board above the transport device 100. The last end stop 1 is at the position of the longest board in the throughfeed direction R. Each end stop has a sensor before the stop position that recognizes the approaching board Lᵢ. The transport device 100 is divided into several short, individually driven sections. Depending on the length of this board, the relevant roller conveyor sections are lowered so that the front edge moves into the lowered end stop and is stopped exactly there. All end stops 2 to 5 positioned in front of this stop allow the first board to pass through. Their sensors count the passes. End stop 2 allows a board to pass through and stops the second board that follows. End stop 3 allows 2 boards to pass through and stops the third board etc.

As can be seen in the path-time diagram in FIG. 5, several boards are travelling at the same time. If there is a large gap, end stop 3 catches its board before end stop 2 catches its board. If an end stop is deactivated (for a continuous board that forms the lintel above cutout A₁, for example), the count changes. If end stop 4 is deactivated, end stop 5 lets three boards through. If end stop 2 is deactivated, end stop 3 only allows one board through, end stop 4 two and end stop 5 three.

Once all the boards are in position, they are pushed to the side of the transport device 100 by a pushing device 103, for example in the form of a side pusher. This side pusher 103 is arranged like a comb between every second roller 101 (see FIG. 6). When retracting, the side pushers 103 lower below the roller level. The following boards can then immediately enter again and are guided along the ruler 102, which can be adjusted to the width of the board. This ruler 102 is slotted to pass through the side pushers 103.

With the wide roller conveyor 100 and the large adjustment path of the side guide, the joining station 200 is also suitable for the lateral joining of wider wood fiber panels.

These panels enter the joining station from the opposite side and are positioned with an additional pusher (not shown). The side guide is also used to push off the fiberboard completely. They are equipped with powerful actuators n for this purpose. The side pushers 103 then remain in the lowered position. The side guide must be moved back into position until the next board can be fed in.

Swivelling hydraulic pushers with a narrow spacing of 250 mm take over the laterally pushed boards and press them sideways. All 66 pushers always work over the entire length of the joining station 200, regardless of whether there is a board or a gap. They all run up against a fixed end stop. This ensures that the rear edge of all pushed and glued boards is always in a straight line. In addition, a synchronised shaft over the entire length of the joining station 200 ensures that all sliders move forwards in parallel. Gear wheels and gear racks engage under the sliders. These sliders have a travel distance of 340 mm for maximum 280 mm wide boards. Optionally, travel limiters can be swivelled in to limit the travel for narrow boards to 80 to 140 mm. This allows the cycle time for compacting and returning to be reduced.

Only the immediately preceding board (Aᵢ, Bᵢ) is held in a stable clamping device from above, pressing onto the sliding base and aligned in height. The clamping pressure generates the counter-pressure for joining and levelling. The hydraulic sliders have so much force that they always move to their end position. The clamping devices are also arranged and controlled in a tighter grid of 250 mm. In a gap in the joining plane, which forms a cutout A₁, A₂, they must not exert any counter-pressure so that the section behind can continue to move freely (see FIG. 6). A sensor on the counter-pressure unit recognizes whether the position is occupied by a board or not. Pressure is only built up in the first case. The following board (Lᵢ₊₁, Bᵢ₊₁) then pushes through the preceding board (Lᵢ₊₁, Bᵢ₊₁) and is itself held in the clamping device from above, pressing on the sliding base.

A wall element is composed of several longitudinal layers L and transverse layers Q glued together. The two outer panels are usually transverse layers. In order to achieve good insulating properties, insulating boards (e.g. made of wood fibers) can be inserted between the individual boards in the layers used as intermediate layers.

The insulating boards can be wider than the boards for the longitudinal layers Lᵢ or the transverse layers Q₁. It is advantageous if the panels made with insulating boards are bordered by solid wood on their outer edges. The division when laying the longitudinal layers L or transverse layers Q must then be taken into account accordingly. In the joining station, wooden boards and fiberboards are then glued together alternately at the sides.

The transverse-layer board is first divided into various rectangles, A, B, C, . . . . The width of these rectangles (transverse to the running direction of the boards Bᵢ) must not be greater than the maximum width of the side joining station. In this case, the rectangle A would be divided into several sections A1, A2, . . . An.

These rectangles are rotated by 90° and placed next to each other, resulting in the total length of the first board B₁. The required lengths and positions of boards B₂ to B₁₁ are then calculated accordingly (FIG. 3a).

### REFERENCE LIST

100 transport device, roller conveyor
101 rollers
102 ruler
103 pushing device, side pusher
104 end stop
105 end stop
150 cut-off device, chop saw
160 glueing device
170 rotation device
180 control device
200 joining station
A₁, A₂ cutout
B₁, B₂, . . . Bᵢ, . . . B₁₀, B₁₁ board
L₁, L₂, . . . Lᵢ . . . L₁, L₁₁ board
L longitudinal layer
LE first longitudinal layer
LZ second longitudinal layer
I, II, III, IV, . . . X row
Q transverse layer
Q₁, Q₂, Q₃, . . . Qᵢ, . . . Q₂₃, Q₂₄, Q₂₅ board
R_{L} longitudinal direction
R_{Q} transverse direction
A, B, C, D, E, F partial panels

1. A method for producing cross-laminated timber panels with cutouts, wherein
the cross-laminated timber panels are constructed of
at least one longitudinal layer of boards that are arranged in rows (parallel to each other in a longitudinal direction, and
at least one transverse layer of boards that are arranged in rows (parallel to each other in a transverse direction, comprising the steps
a) dividing the boards in rows in which the cutouts are located into individual boards to create the cutouts in the at least one longitudinal layer;
b) laying the individual boards to form a first longitudinal layer;
c) gluing the individual boards together on longitudinal sides of each of the individual boards;
wherein both the longitudinal layer of boards and the transverse layer of boards are produced in a same joining station;
d) forming a second longitudinal layer from a plurality of individual boards in multiple rows,
wherein in several rows individual boards are laid and glued together on longitudinal sides of individual boards of the plurality of individual boards so as to allow for cutouts,
wherein the second longitudinal layer is stepped in the transverse direction,
wherein an area of the second longitudinal layer corresponds to an area of the first longitudinal layer without the cutouts;
e) dividing the second longitudinal layer into at least two partial panels,
f) rotating the at least two partial panels are by 90°;
g) laying the at least two partial panels rotated by 90° together to form the transverse layer, and joining the at least two partial panels together such that the cutouts are formed during joining; and
h) laying the transverse layer on the longitudinal layer as overlapping layers, and gluing together the overlapping layers.

2. The method according to claim 1, further comprising arranging an insulating panel between each of the individual boards of the transverse layer.

3. The method according to claim 2, further comprising using a board to bound lateral edges running in the transverse direction of the transverse layer.

4. The method according to claim 1 wherein at least one row of the rows formed by the dividing step contains a maximum of five individual boards.

5. The method according to claim 1 further comprising transporting the individual boards to a joining station in the longitudinal direction;
positioning the individual boards at the joining station using adjustable end stops; and, following positioning,
introducing the individual boards into the joining station in the transverse direction.

6. The method according to claim 1 further comprising trimming lateral edges of both the first longitudinal layer and the second longitudinal layer as cross-laminated timber panels before further processing for calibration.

7. The method according to claim 3 wherein the insulating panels are wider than the individual boards.

8. A wooden panel production device for producing cross-laminated timber panels with cutouts, wherein the cross-laminated timber panels are constructed of at least one longitudinal layer of boards that are arranged in rows (parallel to each other in a longitudinal direction, and
at least one transverse layer of boards that are arranged in rows parallel to each other in a transverse direction, comprising:
a cut-off device configured to divide the boards in rows, in which cutouts are located, into individual boards to produce the cutouts in the at least one longitudinal layer;
a glueing device configured to glue longitudinal sides of the boards;
a joining station for laying and pressing the boards to create a first longitudinal layer,
wherein the cut-off device is configured to divide a second longitudinal layer stepped in the transverse direction, wherein an area of the second longitudinal layer corresponds to an area of the first longitudinal layer without the cutouts, and wherein the cut-off device is used to form at least two partial panels;
a rotation device configured to rotate the at least two partial panels by 90°,
wherein the joining station configured to lay the at least two partial panels rotated by 90° together to form the transverse layer and join them together such that the cutouts are also formed; and
a joining device configured to place the transverse layer on the longitudinal layer as overlapping layers, and to glue the overlapping layers together.

9. The wooden panel production device according to claim 8, further comprising a joining device configured to place the transverse layer on the longitudinal layer as overlapping layers, and to glue the overlapping layers together.

10. The wooden panel production device according to claim 9, wherein the joining station comprises the joining device.

11. The wooden panel production device according to claim 8 further comprising a longitudinal layer formation device configured to form the second longitudinal layer from a plurality of individual boards in multiple rows in order to create cutouts, wherein individual boards are laid in several rows and glued together on longitudinal sides of the individual boards to allow for the cutouts, wherein the second longitudinal layer is stepped in the transverse direction R_{Q}, and wherein an area of the second longitudinal layer corresponds to an area of the first longitudinal layer without the cutouts.

12. The wooden panel production device according to claim 8, further comprising:
a transport device configured to transport the boards to the joining station in the longitudinal direction;
adjustable end stops for positioning the boards; and
a pushing device configured to introduce the boards (into the joining station in the transverse direction after positioning.

13. The wooden panel production device according to claim 8 further comprising a trimming device configured to trim the cross-laminated timber panels before further processing so as to calibrate the cross-laminated timber panels.

14. The wooden panel production device according to claim 8 wherein the joining station is configured to arrange an insulating panel between each of the boards for the transverse layer.

15. The wooden panel production device according to claim 8 wherein a separating device is configured to control the glueing device, the joining station, the rotation device, and the joining device so that the wooden panel production device automatically performs a method of producing cross-laminated timber panels.
